(19) United States
(12) Patent Application Publication
(10) Pub. No.: US 2001/0030596 A1
(43) Pub. Date: Oct. 18, 2001

(54) Protective construction for piezo-resistive pressure transducer

(76) Inventor: William J. Barbier, Hazelwood, MO (US)

Correspondence Address: DANIEL E KRAMER, 2009 WOODLAND DRIVE, YARDLEY, PA, 19067, US

(21) Appl. No.: 09/733,441

(22) Filed: Dec. 8, 2000

Related U.S. Application Data
(60) Provisional application No. 60/179,089, filed on Jan. 31, 2000.

(51) Int. Cl. H01C 10/10

(52) U.S. Cl. 338/42; 338/36

(57) ABSTRACT

A protective construction for a piezo-resistive silicon pressure transducer intended for connection to a pressure source that exhibits pressure transients. The construction includes the transducer, a conduit for providing pressure communication between the pressure source and the transducer and a flow restrictive device positioned within the conduit.

### CLAIM FOR PRIORITY

I hereby claim priority based on Provisional Patent Application Ser. No. 60/179,089 filed Jan. 31, 2000.

### FIELD OF THE INVENTION

This invention is directed to protective means for solid state pressure transducers and especially to piezo-resistive pressure transducers that are exposed to rapid pressure changes in the course of measuring refrigerant pressures in compression type refrigeration systems utilizing volatile refrigerants.

### PRIOR ART

In the following discussion, manufacturers of the piezo-resistive assemblies (72 in FIG. 7) will be referred to as manufacturers. Those entities incorporating the transducers into their products will be called assemblers and those to whom the finished devices are sold for direct use in refrigeration systems will be called users. It should be understood that assemblers utilize a high degree of technology in designing and manufacturing their products and that they frequently discover new principles or designs that are new and unobvious and therefore patentable.

Analog pressure gages have long been known that employ Bourdon tubes as the pressure sensing element. A Bourdon tube is a curved tube that has been flattened so that when pressure inside the tube is applied that is greater than the pressure outside the tube the Bourdon tube has a tendency to straighten. A linkage at one end of the bent tube is provided whereby any straightening of the tube is communicated to a pointer rotating over a circular dial. The dial is generally calibrated in pressure units such as psi or Newtons per unit area or Pascals.

Pressure gages relying on Bourdon tubes typically have a small orifice plug, having a fixed orifice, provided in their inlet fitting, immediately adjacent the Bourdon tube itself, to which pressure piping or to which flexible service hoses are connected. There are two main functions provided by such an orifice: First is to minimize rapid fluctuation of the analog needle employed to react to pressure-caused motion of the Bourdon tube, thereby providing an indication of the pressure to which the interior of the Bourdon tube is exposed; Second is to minimize repeated high speed flexures of the Bourdon tube. These high speed flexures cause the Bourdon tube material to crystallize or fatigue and ultimately fail by leaking the pressurized fluid whose pressure the tube is intended to measure.

By contrast, piezo-resistive silicon absolute pressure transducers do not have a flexing element that is subject to fatigue. Therefore, high failure rates of such transducers in refrigeration service were a constant and costly but completely unexpected annoyance. Service persons using the pressure measuring and superheat measuring devices that relied on such transducers, not only lost the use of their measuring device for long period for repair, but also lost respect for and confidence in the assembler that supplied with the devices and whose name was on the product that failed in use. Further, the assembler of the devices that failed in use was obligated, on moral and public confidence grounds to repair or replace the damaged devices not only while they were within the warranty period, but also after they were long out of warranty.

The problem was complicated further when the manufacturers of the piezo-resistive pressure sensors reported, after inspection of the returned devices, that they had suffered internal damage of types they had not seen before. Among the damages they observed were:

Disruption of the adhesive holding the silicon die 76/78 to the sensor base 74;

Disruption of the strain gage network 79 from the die 78;

Disruption of and breaking of the ultra fine wires 82 that connect the strain gage network to the access pins 84.

Further, the transducer manufacturers reported that their transducers had passed a series of stringent pressure change tests, exposing them to very high dP/dT, or pressure changes per unit time, from which their transducers emerged unscathed. Therefore, the transducer manufacturers ascribed the failure of their devices to conditions unknown to them. Conditions they maintained were the entire responsibility of the assembler/manufacturers incorporating their transducers into their product.

After a lengthy series of tests by the assembler/manufacturer of the assemblies in which the transducers were used, they discovered that, as promised by the manufacturer, the transducers could not be damaged merely by subjecting them to rapid pressure change. However, they found by combining the rapid pressure change with those very conditions frequently found in refrigeration systems, that is, liquid refrigerant and tiny solid particles, that damage to the transducers could occur.

This invention therefore is directed toward constructions and means that the inventor discovered were effective in preventing damage to the transducer under conditions related to service use in refrigeration applications.

### BACKGROUND OF THE INVENTION

### OBJECTIVES

This invention is directed toward means for preventing destructive agitation and motion of liquid and solid particles within the shell of a piezo-resistive pressure transducer.

The invention is further directed toward means for limiting agitation and motion of dirt particles, liquids and especially liquid refrigerants to which such transducers may be exposed during periods of use.

The invention is further directed to flow restrictive means positioned between such transducers and their pressure source.

The invention is further directed to flow and velocity restrictive means positioned between such transducers and their pressure sources or from a single transducer to a source of abruptly lower pressure.

The invention is further directed to flow restrictive means having an orifice hole.

The invention is further directed to such flow restrictive means where the effective restrictiveness of the hole in increased by the insertion of a wire or other object having a diameter smaller than the diameter of the hole.

The invention is further directed to such flow restriction generated by a loose fit between a screw plug and a threaded bore.

The invention is further directed to such flow restriction where the diameter of the threaded bore varies whereby turning the plug from a position within the bore having a larger diameter to a position within the bore having a smaller diameter serves to increase the restriction.

The invention is further directed to such flow restrictive means generated by two flow restrictions in sequence.

The invention is further directed to such dual restrictive means further providing a first volume between the transducer and the flow restriction near the transducer and a second volume between the first flow restriction and the second flow restriction.

### SUMMARY OF THE INVENTION

Means for use in an instrument for measuring pressure within a refrigeration system comprising a piezo-resistive silicon transducer, connection means for receiving and for conveying pressure from the system to the transducer and flow restrictive means positioned within the conveying means for minimizing destructive conditions at the transducer arising from pressure changes at the connection means.

### BRIEF DESCRIPTION OF THE DRAWINGS

FIG. 1 shows a device, exhibiting a principle of the invention, having a pressure transducer at one end, a threaded fitting for connection to a refrigeration system at the other end, a conduit joining the fitting with the transducer and a flow restrictive orifice positioned in the conduit at a point nearer the fitting.

FIG. 2 is an enlarged cross section of an orifice plug of the invention showing the orifice hole and a slot for screwing the orifice plug into the device.

FIG. 3 is a cross section of the orifice unit of FIG. 2 having a wire inserted through the orifice hole to increase its flow restrictiveness.

FIG. 4 illustrates a device, exhibiting a principle of the invention, having two flow-restrictive orifices positioned seriatim between the fitting and the transducer, there being provided a first volume between the first and the second orifice and a second larger volume between the second orifice and the transducer.

FIG. 5 is a pass through fitting having the transducer in a tee and a flow restricting orifice in the connection to the transducer.

FIG. 6 shows the fitting end of the device of FIG. 1 where a tapered internal threaded bore within which a non-orificed plug is threaded for providing a variable restriction in the flow path to the transducer.

FIG. 7 shows a much enlarged cross section of a piezo-resistive silicon absolute pressure transducer of the type intended to be protected by the means of the invention.

FIG. 8 shows a typical electrical resistive circuit embedded at 79, on the face of the silicon die, the pressure sensing element of the transducer.

### DETAILED DESCRIPTION OF THE INVENTION

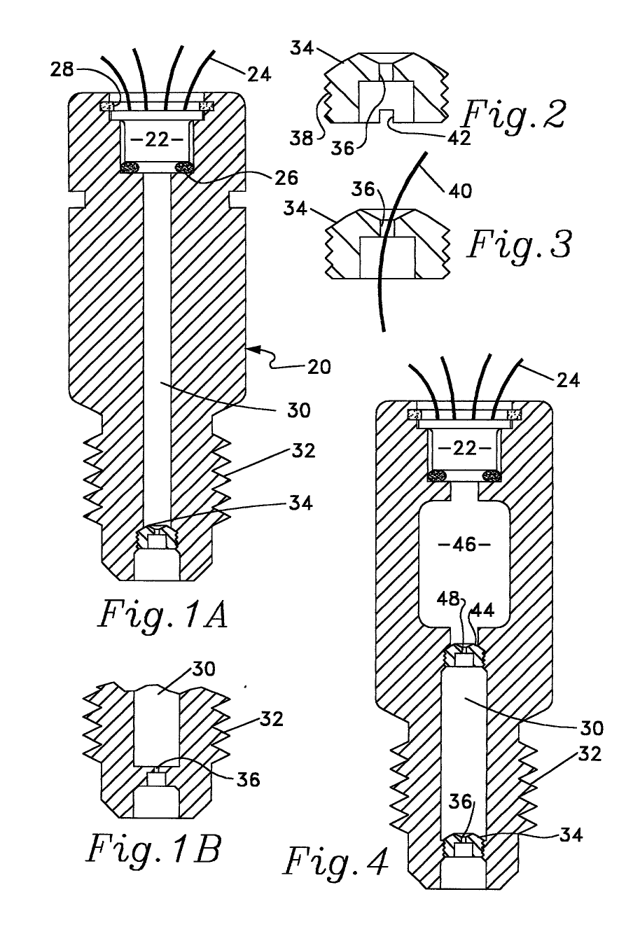

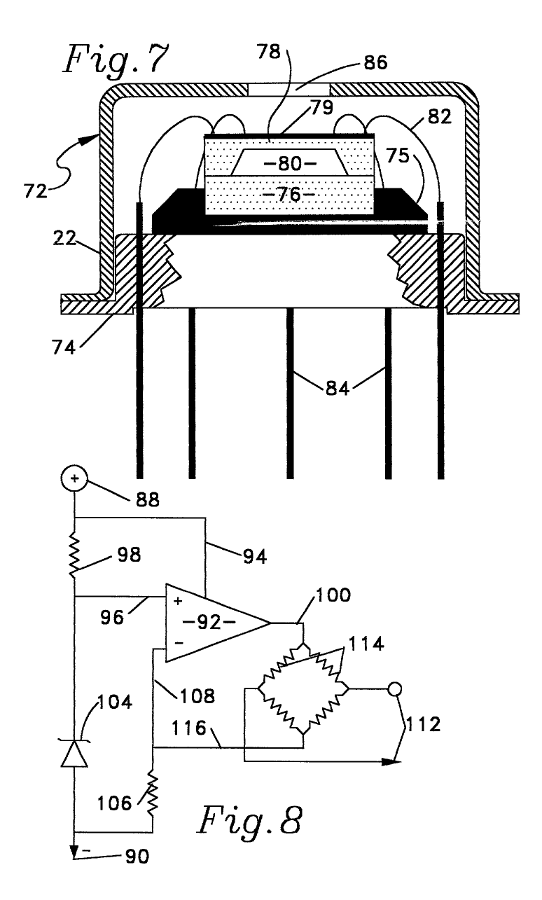

There is shown in FIG. 1A a generalized pressure transducer assembly 20. The assembly 20 is intended to be connected to a compression type refrigeration system via its connection fitting 32. The fitting 32 can be connected to such a system either directly, to a fixed fitting mounted on a refrigerant containing pipe, or indirectly, through a flexible hose having quick-coupling connections such as shown in FIG. 5 at 68. The pressure sensing transducer (shown clearly as 76, 78 and 79 in FIG. 7) is positioned inside casing 22 positioned at the end of assembly 20 opposite fitting 32. A conduit or chamber 30 provides pressure communication between the transducer casing 22 and the fitting 32.

The assembly 20 has provided a cavity at one end for receiving and holding the small drawn casing 22 containing the piezo-resistive silicon pressure transducer. The casing 22 has a diameter about 0.325 inches and a height about 0.205 inches with a mounting flange about 0.363 inches. The casing 22 has protruding therefrom either flexible leads 24 or rigid pins 84, shown in FIG. 7. The diameter of each pin is about 0.020 inches. The casing 22 is positioned in a cavity formed in an end of assembly 20 and is sealed against fluid leakage to the atmosphere from the interior of assembly 20 by O-ring 26. The casing 22 is held securely against the O-ring 26 by locking ring 28. The locking ring 28 is positioned to engage the flange of the casing 22. The end of the casing 22 opposite the flange and locking ring 28 has a hole 86, shown in FIG. 7.

At the end of conduit 30, substantially adjacent connection fitting 32, an orifice fitting 34 is screwed into mating threads formed in the assembly 20. The orifice fitting 34 is provided with orifice hole 36 having a typical diameter in the range of 0.005 to 0.025 inches and a typical length of 1/16 inch. While the length shown in the drawing is relatively short, there is no intention of suggesting any length. In other embodiments of the invention the length of the orifice hole 36 may be substantially greater than the diameter. An example of such a construct would be a capillary tube having, for example, an internal diameter of 0.080 and a length of 12 inches, though other internal diameters and lengths may be found desirable.

In FIG. 1B there is shown a modified section of the fitting part of the assembly 20 of FIG. 1A. In FIG. 1A, the orifice 36 is part of the base material of the assembly 20 and is not part of an orifice plug 34. While this construction is lower in machining cost than the construction of FIG. 1A, the size of orifice 36 is invariant. This is by contrast with the orifice size in FIG. 1A where the orifice size can be changed simply by substituting another orifice plug 34 with a differently sized orifice 36.

Referring now to FIG. 2, an enlarged cross sectional view of orifice fitting 34 is shown. External threads 38 are shown that are employed to screw the orifice fitting into assembly 20. A screw driver slot 42 is provided to facilitate the installation and removal of orifice fitting 34 from assembly 20. The orifice fitting 34 has a hole or orifice 36 traversing it and substantially centrally located. While screw threads 38 and slot 42 are shown, other embodiments of the invention may have the orifice fitting pressed into position at the end of chamber 30 or in the alternative, the orifice hole 36 may be formed into a closed end of assembly 20.

In FIG. 3 there is shown an enlarged cross section of the fitting end of assembly 20 where the orifice hole 36 is formed directly in the end of the assembly. In order to secure a degree of adjustability of the restrictive effect of orifice hole 36, a wire 40 is shown positioned in and traversing orifice hole 36. While the wire 40 is shown, for convenience and clarity, inserted in the enlarged drawing of orifice plug 34 of FIG. 3, it is important to note that the principle and the constructions, arising from application of the principle, apply most effectively and uniquely to the construction of FIG. 1B, where the restriction of the orifice 36 is substantially invariant since it is integral with the metal of the assembly. With the lower cost construction of FIG. 1A the size of the orifice restriction 36 can be readily enlarged, thereby reducing its restrictiveness. However, reducing the size of orifice 36 in the construction of FIG. 1A is not easily accomplished. The construction of FIG. 3, discussed later, teaches a low cost mechanism by which the effective size of the orifice hole 36 in FIG. 1A can be reduced.

In a typical assembly 20 the conduit 30 has a length of 2.25 inches and a diameter of 0.25 inches. Orifice hole 36 has a diameter of 0.050 inches and the size of wire 40 may vary from 0.05 to 0.035 inches, depending on the degree of restriction sought to be provided by orifice hole 36.

Referring now to FIG. 4 there is shown an alternate embodiment of the invention. FIG. 4 shows an assembly similar to assembly 20 of FIG. 1A but employing dual restrictor orifices 36 and 48 and dual chambers 30 and 46.

The more complex construct provides improved filtering of transient system or service pressures, such as those arising when a service technician abruptly uncouples the hose between the sensor and the high pressure side of the system without first bleeding the pressure within the hose to the system lowside. In FIG. 4, chamber 48 is shown having a volume greater than the volume of chamber 30. It should be understood that the volume of the chamber 46 may be larger than, the same as or smaller than the volume of chamber 30, as the requirements of design and construction dictate.

FIG. 5 displays an application of one embodiment of the invention where the transducer casing 22 is mounted in a service device 56. Service device 56 comprises male fitting 32, intended for connection to a flexible hose that could be connected to a vacuum pump or to a refrigerant cylinder; a female coupler 68 intended for connection to a flare fitting such as frequently provided for access on many refrigeration and air-conditioning systems. Pin 69 is employed to depress and thereby open a so-called “Shrader” valve centrally located in such a flare fitting. Naturally, the Shrader valve automatically closes when female coupler 68 is unscrewed and removed. Conduit 70 provides flow communication between male fitting 32 and female fitting 68. The pressure transducer casing 22 is mounted in a tee-off connection to conduit 70. The connection includes an orifice plug 34 having therein orifice 36. While the orifice hole 36 is shown as part of plug 34, in other embodiments of the invention the orifice is integral with the construction material of service device 56 similar to the construction of FIG. 1B. The transducer assembly in casing 22 is mounted in subassembly 64 and is connected to the tee portion of device 56 by threaded connection 66. Chamber 58 provides a flywheel volume between the transducer positioned within casing 22 and orifice 36. A circuit board 60 containing electronic components related to the pressure measuring function is secured to assembly 64 and provided with electrical leads 62 for connection to other components.

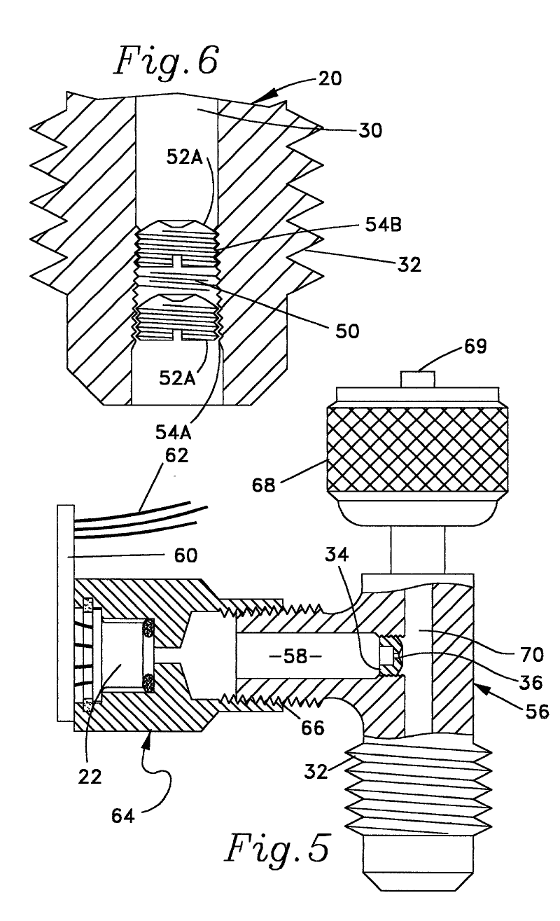

FIG. 6 illustrates an adjustable substitute for the fixed flow restriction 36 of FIGS. 1A and 1B. In FIG. 6 the flow restriction is formed by the clearance 54 between the threaded plug 52. Two degrees of restriction are shown. The smaller restriction is formed between plug 52A and greater bore diameter at 54A. The greater restriction is formed between plug 52A and the lesser bore diameter at 54B.

In FIG. 7 there is shown in cross section a typical silicon piezo-resistive transducer assembly 72. The assembly comprises protective metal casing 22 within which are positioned the pressure sensing components. The casing has an opening 86 at its top to allow pressurized fluid to enter the casing 22 and thereby affect the transducer elements within. The case rests on base 74. Base 74 is formed of a thermoplastic resin, though, for the most severe environments, base 74 is formed of ceramic, a more costly choice. Casing 22 is secured to base 74 with an RTV adhesive, though other adhesive material such as epoxy may be found suitable for other applications. The pressure sensing elements 76, 78 and 79 are positioned within the casing. A rigid silicon constraint wafer 76 is secured to base 74 with an RTV adhesive 75. The silicon die 78, the pressure sensing portion of the transducer, is bonded to the constraint wafer 76 by a glass frit material. The bonding is carried out in a high vacuum at a temperature approaching 450C. The die 78 has deposited, or otherwise formed, on its sensing surface piezo-resistive resistors represented by one or more resistors 114 of FIG. 8. Electrical connection pins 84 traverse base 74. When the base 74 is formed of thermoplastic material, the pins seal effectively to the material. When the base is formed of ceramic, the pins are thermally sealed with a glass frit, in much the same manner that die 78 is secured to constraint wafer 76. Ultra fine wires 82 are bonded to the piezo-resistive elements 79 positioned on die 78. These wires are connected by welding, soldering or other bonding means to pins 84.

In FIG. 8 there is shown a typical basic wiring schematic diagram by which pressures applied to the die 78 and piezo-resistive elements 79 through the opening 86 in case 22 are converted to an electrical response. One or more of the bridge resistors 114 comprise the piezo-resistive elements 79 and are applied to die 78 at its surface. Power in the form of a low voltage electrical supply is applied to positive and negative terminals 88 and 90. The applied voltage, typically, is higher than required by the circuit and it regulated the exact desired value by Zener diode 104. A current limiting resistor 98 is inserted in the power supply circuit 88, 90 to prevent excess current flow through the Zener. Operational amplifier 92 receives its operating power via conductors 94, 96 and 108 with current limiting resistor 106 provided to protect the operational amplifier 92. The operational amplifier 92 provides a regulated voltage output to bridge elements 114 via conductors 100 and 116. The bridge output 112 then varies in some direct relationship to the unbalance in the resistance of bridge elements 114 that correspond directly to the absolute pressure applied to die 78. The output 112 is generally amplified and then employed to actuate a digital or analogue meter or supply information to a calculation procedure or program stored in a microchip, not shown.

From the foregoing description, it can be seen that the present invention comprises an advanced and unobvious construction for minimizing destructive pressure excursions and violent motion of liquid refrigerant and associated solid particles that are frequently associated with a piezo-resistive pressure transducer installed on refrigerating systems. It will be appreciated by those skilled in the art that changes could be made to the embodiments described in the foregoing description without departing from the broad inventive concept thereof. It is understood, therefore, that this invention is not limited to the particular embodiment or embodiments disclosed, but is intended to cover all modifications and elements and their equivalents that are within the scope and spirit of the invention as defined by the appended claims.

1. A protective construction for a piezo-resistive silicon pressure transducer intended for connection to a pressure source exhibiting pressure transients comprising:
said transducer;
conveying means for providing pressure communication between the source and the transducer;
and means positioned within the conveying means for reducing the magnitude of a pressure transient exhibited by the source.

2. Pressure transducer protective construction as described in claim 1 further providing that the transient reducing means comprises a first flow restriction.

3. Pressure transducer protective means as described in claim 2 where the flow restriction is an orifice integral with the construction.

4. Pressure transducer protective construction as described in claim 2 further providing that the flow restriction is in the form of a plug having an orifice.

5. Pressure transducer protective construction as described in claim 3 further providing means for increasing the restrictiveness of the flow restriction, said means comprising a wire positioned within and traversing the orifice.

6. Pressure transducer protective construction as described in claim 2 further providing that the flow restriction is in the form of a threaded plug positioned within a threaded bore and the restriction comprises the gap between the plug threads and the bore threads.

7. Pressure transducer protective means as described in claim 6 further providing that the threaded bore is tapered whereby positioning the plug at different positions within the bore changes the degree of restrictiveness of the flow restriction.

8. Pressure transducer protective construction as described in claim 2 further providing a second flow restriction positioned seriatim within the conveying means, said second restriction being spaced apart from the first restriction and positioned closer to the transducer.

9. Pressure transducer protective means as described in claim 8 further providing a first volume positioned between the second flow restriction and the transducer and a second volume positioned between the first flow restriction and the second flow restriction.

10. Pressure transducer protective means as described in claim 9 further providing that the first volume is greater than the second volume.

11. Pressure transducer protective means as described in claim 9 further providing that the second volume is greater than the first volume.

12. A substantially portable pressure transducer assembly comprising a first fitting for connection to a pressure source, conduit means connecting to the first fitting and means for communicating pressure from the conduit means to a piezo-resistive silicon transducer, said pressure communicating means including a flow restriction.

13. A substantially portable pressure transducer assembly as described in claim 12 further providing that the first fitting includes a valve opening pin centrally positioned within the fitting.

14. A substantially portable pressure transducer assembly as described in claim 13 further providing a second fitting connected to the conduit and adapted for connection to a flexible hose.

15. The process of protecting a piezo-resistive silicon pressure transducer from pressure transients prevailing in a pressure source comprising the steps of:
providing flow means for connecting the pressure transducer to the source;
providing a first flow restriction positioned within the flow means.

16. A process as described in claim 15 further providing a first and a second flow restriction positioned within the flow means, seriatim with the first flow restriction.
